(19) United States
(12) Patent Application Publication
(10) Pub. No.: US 2026/0351632 A1
(43) Pub. Date: Nov. 5, 2026

(54) GAS DIFFUSION LAYER FOR FUEL CELLS, HAVING A GRADIENT OF PROPERTIES AND LOW PLASTIC DEFORMABILITY, AND METHOD FOR PRODUCING SAME

(71) Applicant: Carl Freudenberg KG, Weinheim (DE)

(72) Inventors: Achim BOCK, Weinheim (DE); Kristof KLEIN, Weinheim (DE); Christoph RAKOUSKY, Ober-Ramstadt (DE); Hannes BARSCH, Heidelberg (DE); Matthias LÖBLE, Mannheim (DE); Amélie VON SPEE, Mannheim (DE)

(21) Appl. No.: 19/120,806

(22) PCT Filed: Oct. 11, 2023
(86) PCT No.: PCT/EP2023/078171

§ 371 Date: Apr. 14, 2025

(30) Foreign Application Priority Data
Oct. 18, 2022 (DE) 10 2022 127 228.1

(51) Int. Cl. H01M 8/0245; H01M 8/0234; H01M 8/0239; H01M 8/0243; H01M 8/10

(52) U.S. Cl. CPC H01M 8/0245; H01M 8/0234; H01M 8/0239; H01M 8/0243; H01M 2008/1095

(57) ABSTRACT

A gas diffusion layer for a fuel cell, including a flat electrically conductive fiber material, and a microporous layer on at least one of the surfaces of the fiber material. The microporous layer relative to a base surface of the gas diffusion layer, in an x, y plane, has at least one property gradient with respect to at least one chemical and/or physical property. The fiber material is coated with a precursor to form the microporous layer, where a composition of the precursor is varied to produce a gradient. The coated fiber material is subjected to a post-treatment at elevated pressure and/or elevated temperature.

### CROSS REFERENCE TO RELATED APPLICATIONS

This application is a U.S. National Phase application under 35 U.S.C. § 371 of International Application No. PCT/EP2023/078171, filed on Oct. 11, 2023, and claims benefit to German Patent Application No. DE 10 2022 127 228.1, filed on Oct. 18, 2022. The International Application was published in German on Apr. 25, 2024 as WO 2024/083602 A1 under PCT Article 21(2).

### FIELD

The present disclosure relates to a method for manufacturing a gas diffusion layer for a fuel cell with a property gradient and with a low plastic deformability (e.g. a low setting behavior). The present disclosure also describes gas diffusion layers obtainable by this method and to a fuel cell comprising such a gas diffusion layer.

### BACKGROUND

Fuel cells use the chemical conversion of a fuel, in particular hydrogen, with oxygen to form water in order to generate electrical energy. In hydrogen-oxygen fuel cells, hydrogen or a hydrogen-containing gas mixture is fed to the anode, where an electrochemical oxidation takes place with the release of electrons (H₂→2 H⁺+2 e⁻). A transport of the protons from the anode chamber to the cathode chamber takes place via a membrane that separates the reaction chambers from each other in a gas-tight manner and insulates them electrically. The electrons provided at the anode are fed to the cathode via an outer conductor circuit. The cathode is supplied with oxygen or a gas mixture containing oxygen, whereby the oxygen reduction takes place under absorption of the electrons. The oxygen anions formed thereby react with the protons transported across the membrane to form water (1/2 O₂+2 H⁺+2 e⁻→H₂O).

Low-temperature proton exchange membrane fuel cells ((PEMFCs), also known as polymer electrolyte membrane fuel cells) are used for many applications, especially in the automotive drivetrain, the core element of which is a polymer electrolyte membrane (PEM), which is only permeable to protons (and/or oxonium ions H₃O⁺) and water and spatially separates the oxidizing agent, generally atmospheric oxygen, from the reducing agent. A catalyst layer, which forms the electrodes and usually contains platinum as the catalytically active metal, is applied to the gas-tight, electrically insulating, proton-conducting membrane on the anode and cathode side. The actual redox reactions and charge separations take place in the catalyst layers. The membrane and catalyst layers form a single unit, which is also known as a CCM (catalyst coated membrane). On both sides of the CCM there is a gas diffusion layer (GDL), which stabilizes the cell structure and performs transport and distribution functions for reaction gases, water, heat and electricity. The membrane, electrodes and gas diffusion layer form the membrane electrode assembly (MEA). Flow distribution plates (so-called bipolar plates) are arranged between the membrane electrode assemblies, which have channels for supplying the adjacent cathode and anode with process gases and, as a rule, additional internal cooling channels.

The gas diffusion layers play a crucial role in the function and performance of the fuel cell. On the one hand, they transport the process components consumed and generated in the electrode reactions and, on the other hand, they conduct the electrons generated and consumed in the half-cell reactions and the heat generated during the reaction to the flow distributor plates. In addition, the GDL also acts as a mechanical balance between the macro-structured flow distributor plate and the catalyst layers. For this purpose, component tolerances must be compensated and the compression pressure must be distributed. The GDL also serves as mechanical protection for the very thin membranes, which are exposed to high loads in the fuel cells. Therefore, high demands are placed on the mechanical properties of the GDL.

Gas diffusion layers for fuel cells typically consist of a carbon fiber substrate that is made hydrophobic with fluoropolymers (e.g. PTFE) and subsequently surface coated with a microporous layer (MPL). The MPL usually consists of a fluorine-containing polymer as a binder (e.g. PTFE) and an electrically conductive material, whereby carbon materials such as carbon black or graphite powder are often used. Other approaches to producing MPLs use carbon black in a silicone or PVA-based binder, for example.

The development of fuel cells suitable for everyday use is an important contribution to the energy transition from fossil fuels to sustainable fuels. There is therefore currently a great need for PEM fuel cells that are improved with regard to the complex property profile described above.

WO 2021/099129 A1 is based on the object of reducing and/or avoiding the disadvantages resulting from the gradients with regard to the chemical composition and/or the operating parameters between the supply and discharge of the operating media. To achieve this object, a gas diffusion layer is used which has a property gradient relative to its base area (in the x,y plane), whereby the distribution of the operating media through the GDL is improved. The performance of the fuel cell can be significantly increased by specifically adapting the GDL properties to the gradients of the operating media, as specified by the ambient conditions of the half-cell reactions. Particularly, the fluctuations in current density across the active surface can be reduced.

WO 2022/002932 A1 describes a gas diffusion layer for a fuel cell having a planar extent and a layer thickness measured perpendicular to the planar extent, wherein at least one of the physical properties, selected from hydrophobicity and permeability, changes from an initial value in an initial region to a final value in a final region in at least one direction along the planar extent. The gas diffusion layer may have a microporous layer applied onto it. Specifically, it is described, for example, to control the hydrophobicity via the content of a hydrophobizing material (such as PTFE) and the permeability via the porosity of the gas diffusion layer. If a microporous layer is applied, its thickness can be influenced, which leads, among other things, to a changing local penetration depth into the carrier layer. The electrical contact resistance, the electrical through plane resistance, the contact angle and the hydrophobicity can be adjusted, for example by using varying local densities or concentrations of a hydrophobizing material. The porosity can also be adjusted by a variable drilling pattern when using a laser. It should be noted that the disclosure of this application is not very specific and there is a lack of information on the implementation of the described concepts, as well as a reworkable exemplary embodiment and technical application-related data.

EP 3957789 A1 describes a gas diffusion layer which, despite its low density, has high thermal conductivity and exhibits good manageability and cell performance. The GDL comprises a carbon fiber felt containing carbon fibers with an average fiber diameter of 5 to 20 μm, wherein at least a portion of the carbon fibers that form the carbon fiber felt has a flat part, where, in a planar view of the surface of the carbon fiber felt, a maximum value of the fiber diameter is observed to be 10 to 50% larger than the average fiber diameter, and the frequency of the flat parts on the surface of the carbon fiber felt is 50 to 200/mm².

When used in fuel cells, GDLs are generally strongly compressed. The properties of GDLs as a result of compression can be characterized by the proportion of the elastic and plastic deformation. In the case of plastic deformation, the gas diffusion layer does not return 100% to its original shape after a stress, but a permanent change in shape remains. The property of a material to permanently change its shape when a tension is applied, i.e. its deformability, is also referred to as “setting.” Materials that have a low plastic deformability have a low setting behavior. The setting behavior of the GDLs known from the prior art is still in need of improvement. If the GDL is tensioned in the fuel cell stack under high pressures, the tensioning forces and dynamic force changes during operation lead to setting. This can lead to a loss of compression pressure in the fuel cell stack, which increases the material resistances of most components and, above all, their contact resistances in the stack. Furthermore an adjustment of the stack design may also be necessary, such as using additional spring packages to compensate for the loss of tension that occurs during setting. This can increase the length of the stacks and the space required to install them. Furthermore, additional measures may become necessary during stack assembly, e.g. by tensioning and releasing the stacks multiple times during assembly before final fixation, which increases the manufacturing effort.

### SUMMARY

In an embodiment, the present disclosure provides a method for producing a gas diffusion layer for a fuel cell, including: A) a flat electrically conductive fiber material; and B) a microporous layer on at least one of the surfaces of the fiber material, wherein the microporous layer relative to a base surface of the gas diffusion layer, in an x, y plane, has at least one property gradient with respect to at least one chemical and/or physical property, and wherein: i) the flat electrically conductive fiber material A) is provided, ii) the fiber material provided in step i) is coated with a precursor to form the microporous layer, wherein a composition of the precursor is varied to produce a gradient, iii) the coated fiber material is obtained in step ii) is subjected to a post-treatment at elevated pressure and/or elevated temperature.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows the top view of a GDL material whose production is described in Example 1. Four laterally adjacent strips with four different MPL pastes (paste 1 to 4), each 7 to 8 cm wide, were applied in the longitudinal direction to a fiber web in DIN A3 format (29.7×42 cm, where md denotes the machine direction). Gas diffusion layers having a format of 274.8×96.5 mm were punched out of the dried and sintered material with the long side perpendicular to the machine direction. FIG. 1 shows three alternative punching positions (GDL 1 to 3). The resulting GDLs have a property gradient in the direction of the x-axis, wherein the GDL 1 has four strips with different properties and GDL 2 and 3 each have three strips with different properties. In embodiments, other punching positions and other formats are applicable, which can also have an angle other than 90° to the x-axis in order to vary the gradients. The GDL can also be punched out in other shapes, e.g. squares, ovals, circles, in order to produce further GDL variants, each with individual gradients. The GDLs according to the present disclosure were subjected to post-treatment at elevated pressure and elevated temperature. The GDLs that were not post-treated serve as a comparison;

FIG. 2 shows the plastic deformation properties (setting behavior) based on the compression set values at 6 bar for the four strips of the comparative GDL (left bars) and the GDL according to the present disclosure (right bars);

FIG. 3a shows for the four strips of the comparative GDL the dry diffusion length in μm (triangles), the thickness of the GDL at 2 MPa in μm (squares) and the Gurley values in s (circles);

FIG. 3b shows for the four strips of the GDL according to the present disclosure the dry diffusion length in μm (triangles), the thickness of the GDL at 2 MPa in μm (squares) and the Gurley values in s (circles); and

FIG. 4 shows for the four strips the change in the properties of the dry diffusion length (triangles) and the Gurley values (circles) as a result of post-treatment at increased pressure and temperature. The graphs show the differences in the values (Δ values) for the GDL according to the present disclosure (GDL 1) and the comparative GDL (GDL V1).

### DETAILED DESCRIPTION

Embodiments of the present disclosure avoids or at least reduces the disadvantages described above. Surprisingly, it has now been found that gas diffusion layers with a good property profile, especially with regard to their transport properties, and with significantly improved setting behavior can be achieved if the gas diffusion length is given a property gradient with regard to at least one chemical and/or physical property in relation to its base area (in the x,y plane) and is subjected to post-treatment at elevated pressure and, if necessary, elevated temperature. In this way, the plastic deformation portion of the GDL can be significantly reduced. Surprisingly, it was found that this post-treatment can also have a positive effect on the gradients. In the transport properties, such as gas permeability and dry diffusion length, even more pronounced gradients can be achieved.

A first aspect of the present disclosure includes is a method for manufacturing a gas diffusion layer for a fuel cell, comprising:
A) a flat electrically conductive fiber material, and
B) a microporous layer on at least one of the surfaces of the fiber material, wherein the microporous layer, with respect to the base surface of the gas diffusion layer (in the x,y plane), has at least one property gradient with respect to at least one chemical and/or physical property, Where:
i) a flat electrically conductive fiber material A) is provided,
ii) the fiber material provided in step i) is coated with a precursor for forming a microporous layer B), wherein the composition of the precursor is varied to produce a gradient,
iii) the coated fiber material obtained in step ii) is subjected to a post-treatment at elevated pressure and, if appropriate, elevated temperature.

Embodiments of the present disclosure include a gas diffusion layer obtainable by a method as described above and below.

Embodiments of the present disclosure include a gas diffusion layer for a fuel cell, comprising:
A) a flat electrically conductive fiber material; and
B) a microporous layer on at least one of the surfaces of the fiber material,
wherein the gas diffusion layer has, in relation to its base area (in the x,y plane), at least one property gradient with respect to at least one chemical and/or physical property and the gas diffusion layer has been subjected to a post-treatment at increased pressure and optionally increased temperature, so that it has a reduced plastic deformability compared to a non-post-treated gas diffusion layer.

In embodiments, the gas diffusion layer has a reduced compression set value compared to a non-post-treated gas diffusion layer.

Embodiments of the present disclosure include a fuel cell comprising at least one gas diffusion layer as described above and below.

Embodiments of the present disclosure include the use of a gas diffusion layer, as described above and below, or obtainable by a method as described above and below, in a proton exchange membrane fuel cell.

The gas diffusion layers according to embodiments of the present disclosure and obtained by the method according to the present disclosure have the following advantages:
The gas diffusion layers have a significantly improved setting behavior. The plastic deformation portion of the GDL can be significantly reduced by the post-treatment according to the present disclosure at increased pressure and, if necessary, increased temperature.
Design measures for adapting the fuel cell stacks to the consequences associated with setting the GDL, such as reduced compression pressure, increased material resistance of the installed components and a voltage loss, can be reduced or dispensed with altogether.
Surprisingly, it was found that post-treatment can also have a positive effect on the gradients. Particularly in the transport properties, such as gas permeability and dry diffusion length, even more pronounced gradients can be achieved. In addition, the raw materials used to generate the gradients lead to highly plastic deformation behavior without post-treatment. Different areas of the gradient can exhibit different setting behavior. This is not only significantly minimized by the post-treatment according to the present disclosure, the different areas of the gradient are generally also homogenized.
The properties of the GDL can be specifically adapted to the operating conditions of the respective fuel half-cell by means of the at least one property gradient exhibited by the gas diffusion layers according to the present disclosure. The GDL is characterized by improved properties with regard to the distribution of the operating materials. Specifically, it is possible to control various transport processes through the GDL independently of each other. For example, the transport of liquid water and gaseous water can be set separately. The oxygen transport through the GDL to the cathode can also be specifically controlled.
The gas diffusion layers according to the present disclosure can be produced easily and inexpensively.
Due to the property gradient of the gas diffusion layers according to the present disclosure, fluctuations in the current density across the active area can be reduced in the resulting fuel cells.

Plastic deformation refers to when a material, such as a gas diffusion layer, does not return 100% to its original shape after being subjected to stress, but a permanent change in shape remains. Part of the deformation is elastic and therefore reversible, only a certain part is plastic and remains permanent. The property of a material to permanently change its shape when tension is applied, i.e. its deformability, is also referred to as “setting”. Materials that have a low plastic deformability have a low setting behavior. Gas diffusion layers with a low setting behavior are characterized by low compression set values. The compression set and methods for measuring it are described in detail below.

A method according to the present disclosure comprises the following steps:
i) providing a flat electrically conductive fiber material A),
ii) coating the fiber material provided in step i) with a precursor for forming a microporous layer B), wherein the composition of the precursor is varied to produce a gradient,
iii) post-treatment of the coated fiber material obtained in step ii) at elevated pressure and, if necessary, elevated temperature.

Regarding the fiber materials A) and the precursors and conditions for forming a microporous layer B), full reference is made to the embodiments described below.

iii) Post-Treatment at Elevated Pressure and Temperature

In embodiments, the treatment in step iii) is carried out at an elevated pressure of at least 0.5 MPa and an elevated temperature of at least 100 °C.

Preferably, the treatment in step iii) is carried out at a pressure in the range from 5 to 100 bar (0.5 to 10.0 MPa), particularly preferably from 15 to 80 bar.

Preferably, the treatment in step iii) is carried out at a temperature in the range from 100 to 350 °C, particularly preferably from 120 to 330 °C, especially from 150 to 320 °C.

Preferably, the treatment in step iii) is carried out in a press over a period of 5 seconds to 5 minutes, preferably 10 seconds to 2 minutes.

Preferably, the treatment in step iii) is carried out in a calender over a period of greater than 0 seconds to 10 seconds, preferably from 0.1 seconds to 5 seconds.

Devices such as single-deck or multi-deck presses, endless belt presses or calenders can be used for post-treatment in step iii). In embodiments, at least one double belt press is used for post-treatment in step iii). In some embodiments, at least one calender is used for post-treatment in step iii).

Single-deck presses or multi-deck presses are particularly suitable for the discontinuous post-treatment of sectional materials. Double belt presses are suitable for treating both endless web-shaped materials and sectional materials (sheet material). Double belt presses have two endless circulating press belts, between which the GDL web is post-treated under the influence of pressure and, if necessary, also heat while being transported in the feed direction. The belts are aligned parallel to each other, and there is a gap between the upper and lower belt that can be opened and closed to adjust to the thickness of the GDL material and to set the desired properties.

In an embodiment, the treatment in step iii) is carried out in a double belt press. In particular, the treatment in step iii) is carried out in a double belt press at a pressure in the range from 1 to 8 MPa (10 to 80 bar) and at a temperature in the range from 200 to 350 °C.

In an embodiment, the treatment in step iii) is carried out in a calender. In principle, known and commercially available calenders can be used in step iii) of the method according to the present disclosure. Thus, it is possible to use calenders with 2, 3, 4 or more than 4 calender rolls. In embodiments, the calender used in the method according to the present disclosure is a two-roll calender. The gas diffusion layer can be passed through the calender once or repeatedly, e.g. 1, 2, 3, 4, 5 or more than 5 times. The calender rolls can be arranged in a geometry that is suitable for calendering the gaseous diffusion layers. A two-roll calender can have a vertical, inclined or horizontal arrangement of the rolls. A three-roll calender can have a vertical arrangement, a top roll arranged in an offset manner or a bottom roll arranged in an offset manner. A four-roll calender can have an L arrangement, an inverted L arrangement, an S arrangement, a Z arrangement or another arrangement of the rolls.

Preferably, the treatment in step iii) is carried out in a calender at a line pressure in the range of 5 to 500 N/mm, preferably 10 to 100 N/mm.

Preferably, calendering in step iii) is carried out at a web speed of 0.05 m/min to 30 m/min.

The treatment in step iii) is carried out in a calender at a roll temperature in the range from 130 to 220 °C at a line pressure in the range from 8 to 80 N/mm and a web speed of 1 to 10 m/min.

### Flat Electrically Conductive Fiber Material A) and Gas Diffusion Layer (GDL)

Within the scope of the present disclosure, a nonwoven web generally refers to a sheet-like structure that mainly consists of individual fibers, whose cohesion is essentially only provided by their inherent adhesion. The conversion of a nonwoven web into a nonwoven, by creating a stronger bond between the fibers than is present in the nonwoven web is achieved through nonwoven bonding processes, which are typically categorized into mechanical, chemical, and thermal processes. Nonwoven webs, nonwovens, and the processes for their production are described in H. Fuchs, W. Albrecht, Vliesstoffe, 2nd edition, Wiley-VCH, Weinheim, Germany.

The flat electrically conductive material A) used according to the present disclosure and the gas diffusion layer are a sheet-like structure that has a substantially two-dimensional, planar extension and a comparatively smaller thickness. The gas diffusion layer according to the present disclosure has a base area which generally corresponds essentially to the base area of the adjacent membrane with the catalyst layers and the base area of the adjacent flow distributor plate. The shape of the base area of the gas diffusion layer can, for example, be polygonal (n-angled with n≥3, e.g. triangular, square, pentagonal, hexagonal, etc.), circular, circular-segment-shaped (e.g. semicircular), elliptical or elliptical-segment-shaped. Preferably, the base area is rectangular or circular. Within the context of the present disclosure, an orthogonal coordinate system is used to describe the GDL, wherein with the base area of the GDL lies in the plane spanned by the x-axis and the y-axis (also referred to as the x,y plane). The thereto orthogonal z-axis serves to describe the material thickness. According to the usual description for fiber composite materials, the x-axis is also described as the machine direction (MD) and the y-axis as the cross machine direction (CMD). In the direction of the z-axis, the material is essentially transported between the flow distribution plate and the membrane.

According to the present disclosure, the gas diffusion layer has at least one property gradient with respect to at least one chemical and/or physical property. This means that at least one property of the gas diffusion layer is dependent on the location. The property gradient can extend over one, two or all three spatial directions. It can extend over the entire length extension in one spatial direction or over a specific section. The property change can be erratic (i.e. the gaseous diffusion layer according to the present disclosure exhibits heterogeneity with respect to at least one property) or continuous (i.e. the gaseous diffusion layer according to the present disclosure exhibits inhomogeneity with respect to at least one property). An erratic change in properties generally has at least 2, preferably at least 3, in particular at least 4 stages with regard to the property exhibiting the gradient. Both the flat fiber material A) and the microporous layer B) as well as both can exhibit the at least one property gradient.

Preferably, at least the microporous layer B) exhibits at least one property gradient. Preferably, at least the cathode-side gas diffusion layers of the fuel cells according to the present disclosure exhibit an MPL which exhibits a property gradient with respect to the base area (in the x,y plane) of the GDL. By using an MPL that has a property gradient with respect to the base area (in the x,y plane) of the GDL a more uniform current density distribution of the fuel cell can be achieved. In an embodiment, solely the microporous layer has one or more property gradients.

Preferably, the gas diffusion layer (i.e. the flat fiber material A) and/or the microporous layer B)) has at least one property gradient which changes monotonically as a function of location. A monotonic property change is understood to mean that the function value representing the property change either always increases or always decreases when the value for the location coordinate increases. Thereby it is permissible for the function value, which represents the change in property, to remain constant over a partial range or over multiple partial ranges along the course of the spatial coordinate. However, it does not have any local minima or maxima.

Preferably, the gas diffusion layer (i.e. only the flat fiber material A) or only the microporous layer B) or the flat fiber material A) and the microporous layer B) only exhibit property gradients that change monotonically as a function of location.

Preferably, at least the microporous layer B) has at least one property gradient which changes monotonically as a function of the location. In an embodiment, exclusively the microporous layer has at least one property gradient which changes monotonically as a function of location. In embodiments, the microporous layer exclusively has property gradients that change monotonically as a function of location. More specifically, the microporous layer has only a single property gradient and this one property gradient changes monotonically as a function of location.

The gas diffusion layer comprises at least one electrically conductive flat fiber material as component A). Preferably, component A) comprises a fiber material selected from nonwoven webs, papers, fabrics and combinations thereof. Suitable substrate materials are fiber materials that are themselves conductive or are made conductive by the addition of conductive additives, such as carbon or metal particles. In principle, carbon fibers, glass fibers, fibers of organic polymers such as polypropylene, polyester, polyphenylene sulfide, polyether ketones and mixtures thereof are suitable as substrate materials. The fibers contained in the fiber material A) preferably comprise or consist of carbon material fibers (carbon fibers, carbon reinforced fibers). Such fiber materials are particularly advantageous in meeting the GDL requirement for gas diffusivity, liquid water permeability, electrical and thermal conductivity. The fiber material A) is preferably selected from carbon fiber fabrics, carbon fiber papers and carbon fiber nonwovens. In an embodiment, the fiber material A) comprises at least one carbon fiber nonwoven or the fiber material A) consists of a carbon fiber nonwoven.

The carbon material fibers can be produced in the usual way, whereby preferably polyacrylonitrile fibers (PAN fibers) is used as the starting material. PAN fibers are produced by radical polymerization of a monomer composition that preferably contains at least 90% by weight of acrylonitrile, based on the total weight of the monomers used for polymerization. The polymer solution obtained is spun into filaments, e.g. by wet spinning and coagulation, and combined to form ropes. Before this PAN precursor is converted into carbon material fibers at high temperatures, it is usually subjected to oxidative cyclization (also referred to as oxidation for short) in an oxygen-containing atmosphere at elevated temperatures of around 180 to 300 °C. The resulting chemical cross-linking improves the dimensional stability of the fibers. The actual pyrolysis to carbon material fibers then takes place at temperatures of at least 1200 °C. Depending on the shape of the desired fiber material, either the starting fibers or a flat fiber material can be used for this pyrolysis. Depending on the pyrolysis temperature, a distinction is made between carbonization and graphitization. Carbonization refers to a treatment at around 1200 to 1500 °C in an inert gas atmosphere, which leads to the separation of volatile products. Graphitization, i.e. heating to around 2000 to 3000 °C in an inert gas atmosphere, produces so-called high-modulus fibers or graphite fibers. These fibers have a high degree of purity, are light, extremely strong and very good conductors of electricity and heat.

The fiber material A) is preferably selected from carbon fiber fabrics, carbon fiber papers and carbon fiber nonwovens.

For carbon fiber fabrics, the flat fiber material is produced by interlacing two thread systems, warp (warp threads) and weft (weft threads). As with textiles, fiber bundles are joined together flexibly but inseparably. Oxidized but not yet carbonized or graphitized PAN fibers are preferably used for producing carbon fiber fabrics. The carbonization or graphitization to give the flat fiber material electrical conductivity takes place after weaving.

As described above, oxidized PAN fibers are generally used for the production of carbon fiber papers. These fibers are processed in a known manner by being crushed into fiber fragments, dispersed into a slurry, and formed into a fiber mat via a sieving process (vat) analogous to conventional papermaking, followed by drying. In an embodiment, at least one binder is additionally incorporated into the paper. Suitable binders are, for example, phenolic, furan, polyimide resins, etc. To introduce the binder, the paper can be impregnated with it and the binder can then be hardened if necessary. After impregnation and hardening, the carbon fiber paper is again subjected to carbonization/graphitization in order to also convert the binder into compounds with improved electrical conductivity. In embodiments, a filled carbon fiber paper is used to provide the fiber material A). The production is initially carried out as described above, however, instead of introducing a binder and the carbonization/graphitization, a filler consisting of a carbon material in a polymer binder is introduced into the still moist paper. Specifically, a carbon-PTFE filler is used for this purpose. This filling increases the thermal and electrical conductivity to such an extent that carbonization/graphitization can be omitted.

Non-oxidized or oxidized PAN fibers can be used to produce carbon fiber nonwovens. In a first step, these can be dry laid (carded) to form a pile and then bonded to form a nonwoven. This can be achieved, for example, by hydro-entanglement (hydro-entangling), whereby the carbon fibers are oriented, entangled and thus mechanically stabilized. If necessary, the thickness of the bonded nonwoven can be calibrated to a desired value. Nonwovens based on non-oxidized PAN fibers are, after web laying and bonding, first subjected to oxidation at elevated temperature and under oxygen atmosphere, and subsequently to carbonization/graphitization under inert gas atmosphere. Nonwovens based on oxidized PAN fibers are only subjected to carbonization/graphitization after web laying and bonding. Optionally, at least one binder can additionally be introduced into the nonwoven web and, if necessary, subsequently hardened. Suitable binders are those mentioned for carbon fiber papers, especially phenolic resins. The binder can be introduced after carbonization/graphitization, for example, and the resulting impregnated nonwoven web can then finally be carbonized/graphitized again.

In an embodiment, the flat electrically conductive fiber material A) comprises at least one carbon fiber nonwoven. These are advantageous, among other things, because they are compression-elastic and can be easily produced on a large scale, i.e. in a roll-to-roll process.

The fiber material A) is usually a fiber composite material comprising:
a1) carbon fibers,
a2) if applicable at least one polymeric binder and/or a pyrolysis product thereof,
a3) if applicable at least one further additive different from a2).

The fiber materials A) contained in the gas diffusion layer may contain conventional additives a3). These are preferably selected from hydrophobizing agents, conductivity-improving additives, surface-active substances and mixtures thereof.

To improve the transport processes through the GDL and at the interfaces, it can be advantageous to increase the hydrophobicity of the fiber material A). Suitable hydrophobizing agents are fluorine-containing polymers, such as polytetrafluoroethylene (PTFE) and tetrafluoroethylene-hexafluoropropylene copolymers (FEP). PTFE is the preferred hydrophobizing agent. The fiber material can be treated with the hydrophobizing agent using conventional impregnation processes. For this purpose, a PTFE dispersion can be applied in an immersion bath, the solvent evaporated and the treated fiber material sintered at elevated temperatures of generally at least 300 °C.

Preferably, the fiber material A) has a content of hydrophobizing agents of 3 to 40% by weight, based on the total weight of the fiber material A). In an embodiment, the fiber material has a PTFE content of 3 to 40% by weight, based on the total weight of the fiber material A).

To improve the electrical and thermal conductivity, the fiber material A) can be finished with at least one conductivity-improving additive. Suitable conductivity-improving additives are, for example, metal particles, carbon particles, etc. Preferably, the conductivity-improving additive is selected from carbon black, graphite, graphene, carbon nanotubes (CNT), carbon nanofibers and mixtures thereof. The finishing of the fiber material A) with at least one conductivity-improving additive can, for example, be carried out together with the hydrophobizing agent, in particular a PTFE dispersion. In many cases, the fiber material A) has good electrical and thermal conductivity due to the carbon fibers used, even without conductivity-improving additives.

Preferably, the fiber material A) has a content of conductivity-improving additives of 0 to 40% by weight, based on the total weight of the fiber material A). If the fiber material A) contains a conductivity-improving additive, then preferably in an amount of from 0.1 to 40% by weight, particularly preferably from 0.5 to 30% by weight, based on the total weight of the fiber material A).

The fiber material A) preferably has a thickness in the range from 50 to 750 μm, particularly preferably from 100 to 500 μm. This thickness refers to the uncompressed state of the fiber material A), i.e. before post-treatment in step iii) and before installation of the GDL in a fuel cell.

The fiber material A) preferably has a porosity in the range of 10 to 90%, particularly preferably from 20 to 85%. The porosity of the fiber material can be calculated from the measured thickness and the measured area weight if the fiber density is known. Thus, for a carbon fiber density of 1.8 g/cm³, the following applies: porosity [%]=[(1.8 area weight/thickness)/1.8]×100. Furthermore, it is possible to determine the density of the gas diffusion layer by helium density measurement and the specific pore volume by mercury porosimetry. The porosity is then calculated as follows: porosity [%]=specific pore volume/(specific pore volume+1/He density)×100%].

The average pore diameter of the fiber material A) is preferably in the range from 5 to 60 μm, particularly preferably from 8 to 50 μm, especially from 10 to 40 μm. The average pore diameter can be determined by mercury porosimetry.

The gas diffusion layer according to the present disclosure consists of a two- or multi-layer composite based on a flat, electrically conductive fiber material A) and a microporous layer (MPL) B) on one of the surfaces of the fiber material A).

In contrast to the macroporous fiber material A), the MPL B) is microporous with pore diameters that are generally well below one micrometer, preferably of at the most 900 nm, particularly preferably of no more than 500 nm, especially of no more than 300 nm. The average pore diameter of the MPL B) is preferably in a range from 5 to 200 nm, particularly preferably from 10 to 100 nm. The average pore diameter can again be determined by mercury porosimetry. The latter mentioned average pore diameters apply above all to the use of carbon black as conductive particles in the MPL. Significantly larger MPL pores can also be produced by using graphite as conductive particles in the MPL or by using pore-forming agents. Depending on the composition, the average pore diameter is then larger than 1 μm, for example.

The MPL contains conductive carbon particles, preferably carbon black or graphite, in a matrix of a polymeric binder. Preferred binders are the aforementioned fluorine-containing polymers, especially polytetrafluoroethylene (PTFE).

The microporous layer B) preferably has a thickness in the range from 5 to 150 μm, particularly preferably from 10 to 100 μm. This thickness refers to the uncompressed state of the microporous layer B), i.e. before post-treatment in step iii) and before installation of the GDL in a fuel cell.

The presence of the MPL has a major influence on the water management of the fuel cell. Due to the high PTFE content and the smaller pores of the MPL, flooding of the GDL and the electrode is made more difficult by the MPL acting as a liquid water barrier and thus favoring the mass transport of the gaseous reactants to the catalyst. It has been shown that it can be advantageous if, in the gas diffusion layer according to the present disclosure, the microporous layer has a property gradient in relation to its base area (in the x,y plane) of the GDL.

The gas diffusion layer according to the present disclosure preferably has a thickness (total thickness of fiber material A) and MPL B)) in the range from 75 to 1000 μm, particularly preferably from 100 to 500 μm. This thickness refers to the uncompressed state of the GDL, i.e. before the post-treatment in step iii) and before its installation in a fuel cell.

Furthermore, the gas diffusion layers preferably have a high total porosity. This is preferably in the range of 20% to 80%, determined as described above by helium density measurement and mercury porosimetry.

### Process for Producing a Gas Diffusion Layer

### Step i)

With regard to the suitable and preferred fiber materials A) used in step i), full reference is made to the previous embodiments.

### Step ii)

The precursors used in step ii) preferably contain at least one fluorine-containing polymer, at least one carbon material and, if applicable, at least one pore-forming agent. The fluorine-containing polymers are preferably selected from polytetrafluoroethylene (PTFE) and tetrafluoroethylene-hexafluoropropylene copolymers (FEP). PTFE is preferably used. Preferably, the carbon material is selected from carbon black, graphite, graphene, carbon nanotubes (CNT), carbon nanofibers and mixtures thereof. Carbon black or graphite is preferably used. In an embodiment, the precursors used in step b) contain at least one pore-forming agent. Suitable pore-forming agents are commercially available plastic particles, e.g. of polymethyl methacrylate (PMMA). A suitable particle size is in the range of 10 to 100 μm.

Preferably, the proportion by volume of the pores in the finished microporous layer which is attributable to the use of a pore-forming agent is 0 to 70% by volume, based on the total volume of the pores in the finished microporous layer.

Preferably, the fiber material A) is coated with at least 2, preferably at least 3, in particular at least 4 laterally adjacent strips of precursors of different composition to form a microporous layer. The MPL can be applied in various ways. While spray coating, screen printing or Meyer-Rod processes are often used in discontinuous manufacturing, doctor blade, slot die and engraved roll processes are preferred for continuous coating. Thereby the MPL layer thickness and the penetration depth can be influenced by the coating process parameters and the viscosity of the coating. This is subsequently followed by renewed thermal treatment, e.g. in a drying and sintering oven. This can involve drying first at a temperature of 100 to 200 °C and then sintering at a temperature of 300 to 500 °C.

### Property Gradient

As previously mentioned, both the flat fiber material A) and the microporous layer B), as well as both can exhibit at least one property gradient.

The property that exhibits the gradient is in principle selected from
the chemical composition of the flat fiber material A) and/or the microporous layer B),
the mechanical properties of the flat fiber material A) and/or the microporous layer B),
the transport properties of the flat fiber material A) and/or the microporous layer B),
combinations thereof.

The chemical properties of the flat fiber material A) and/or the microporous layer B), which may exhibit a gradient, include, for example, the content of hydrophobizing agents, carbon particles, etc. This specifically includes the content of PTFE, carbon black, graphite, graphene, carbon nanotubes (CNT), carbon nanofibers and mixtures thereof.

The mechanical properties of the flat fiber material A) and/or the microporous layer B), which can exhibit a gradient, include, for example, the density, the mass per unit area, the porosity and the average pore diameter.

The specifying of the density in g/m³ can be carried out by measuring the helium density as described above.

The specifying of the mass per unit area in g/m² can be carried out in accordance with ISO 9073-1 or EN 29073-1:1992.

The specifying of the porosity and pore size distribution can be carried out using mercury porosimetry, as described in DIN ISO 15901-1:2019-03 and ISO 15901-1:2016-Part 1: mercury porosimetry.

To generate a gradient in the mechanical properties, for example, the compression behavior of the microporous layer can be provided with a gradient by varying its composition with respect to at least one of its materials. This also changes the connection to the electrode. Alternatively, a gradient in the mechanical properties can be created by generating a gradient across the width of the material during nonwoven bonding through hydroentanglement. This influences the mechanical properties and the water transport.

The transport properties of the flat fiber material A) and/or the microporous layer B), which may have a gradient, include:
the gas permeability of the flat fiber material A) and/or the microporous layer B),
the liquid permeability of the flat fiber material A) and/or the microporous layer B),
the electrical through plane resistance of the gas diffusion layer through the material plane,
the thermal through plane resistance of the gas diffusion layer through the material plane,
the dry diffusion length.

In an embodiment, the microporous layer (MPL) has at least one property gradient with respect to at least one chemical and/or physical property. This includes in particular the mechanical properties and transport properties. The MPL exhibits the at least one property gradient in relation to its base area, i.e. in the top view and/or in the x,y plane. If necessary, the MPL can also have a property gradient perpendicular to its base surface, i.e. in the direction of the z-axis.

Preferably, the microporous layer has at least 2, preferably at least 3, in particular at least 4, especially at least 5, more specifically at least 6 discrete areas which differ in at least one property. In this embodiment, the change in properties between the areas is erratic. The individual areas can all differ with respect to the same property or (in the case of several different properties) the same properties. This is preferred. However, it is also possible for two or more areas to differ with respect to different properties. In an embodiment, the microporous layer has at least 2, preferably at least 3, in particular at least 4, especially at least 5, more especially at least 6 discrete areas, all of which differ with respect to one and the same property.

In an embodiment, each individual area is essentially homogeneous in terms of its properties. Essentially homogeneous is understood to mean that only such fluctuations in properties occur within an area as also occur (i.e. due to production) if a gradient is not deliberately generated.

In an embodiment, the microporous layer has at least one continuous property gradient.

Preferably, the microporous layer has at least 2, preferably at least 3, in particular at least 4 laterally adjacent strips which differ in at least one property. In an embodiment, the microporous layer has at least 2, preferably at least 3, in particular at least 4 laterally adjacent strips which all differ with respect to one and the same property. In particular, each individual strip is essentially homogeneous in terms of its properties.

Preferably, the property of the microporous layer having a gradient is selected from:
the gas permeability according to Gurley and
the dry diffusion length.

### Physical Quantities, Measurement Methods

The gas permeability perpendicular to the material plane can be determined using a Gurley measurement, for which an automated Gurley densometer from the company Gurley Precision Instruments can be used. During the measurement, the time is determined in seconds for 100 cm³ of air at a constant pressure difference to flow vertically through the GDL sample with a sample area of 6.42 cm². The specifying of air permeability according to Gurley is described in ISO 5636-5.

The gas permeability can also be measured in 1/m2 s in accordance with DIN EN ISO 9237:1995-12 to specify the air permeability of textile fabrics.

The permeability for liquids, especially for liquid water, perpendicular to the material plane (liquid-water permeability “through plane”) can be specified with a so-called “filtration cell” or according to the “Penn State” method [see literature references a-c]: [a] I. S. Hussaini and C. Y. Wang, “Measurement of relative permeability of fuel cell diffusion media,” Journal of Power Sources, vol. 195, pp. 3830-3840, 2010; [b] J. D. Sole, “Investigation of water transport parameters and processes in the gas diffusion layer of PEMFCs,” Virginia Polytechnic Institute, 2008; [c] J. Benziger, J. Nehlsen, D. Blackwell, T. Brennan, and J. Itescu, “Water flow in the gas diffusion layer of PEM fuel cells,” Journal of Membrane Science, vol. 261, pp. 98-106, 2005.

The specifying of the (specific) electrical resistance through the plane (through plane, TP) can be carried out by 4-point measurement in a manner known from the literature.

The dry diffusion length is the actual length of the path that a gas molecule travels through the flat fiber material A) and/or the microporous layer B) in μm. It is specified using a stationary Wicke-Kallenbach cell.

Two well-known test methods can be used for specifying the thermal resistance through the plane (through plane TP): the heat flow method or the laser flash method.

The compression set value is a measure of how a material, in this case a GDL, behaves in the event of compression deformation and subsequent relaxation. GDLs are usually highly compressed when used in fuel cells. To characterize the properties of a GDL as a result of compression, the proportion of elastic and plastic deformation (and, if necessary, the specification of other physical variables such as gas permeability and electrical resistance) can be used. Plastic deformation refers to when a material does not return 100% to its original shape after being subjected to stress, but a permanent change in shape remains. The compression set is the permanent deformation that remains after the applied force has been removed.

The specifying of the compression set value can be carried out in the following way. It is possible to simultaneously specify the values of other physical variables, such as thickness, gas permeability, electrical resistance, in each case at a specific compressive force and after a single or multiple application of force.

Three samples (left, right and center) are taken across the entire width of the GDL to be tested, from which an average value is calculated. If the material has a machine direction due to the manufacturing process, the samples are taken perpendicular to the machine direction (CMD). The samples are ring-shaped with an inner diameter of 45 mm and an outer diameter of 56 mm. The sample area is 8.72577 cm². In a testing machine, the samples are subjected to a time-varying compressive force that acts vertically on the surface of the sample. A sensor specifies the change in thickness of the GDL over time with the respective pressure applied. The sample is mounted on a device for determining the elastic and plastic deformation by means of force sensors, whereby the movement is transmitted to the sample via springs. The travel distance until reaching the maximum compressive force is determined by displacement sensors. As the deformation of the sample is non-linear, the measurement data is adapted to the relative change. A measurement cycle, i.e. a single loading up to maximum pressure and the subsequent unloading, lasts 1 min. The sample is subjected to three loading cycles. The initial value, at which only a small force is exerted on the sample, is 0.025 MPa. Typical compression values for specifying the compression set value (and other physical variables such as thickness, electrical conductivity and/or surface resistance, gas permeability, etc.) are e.g. 0.6 MPa, 1.0 MPa and 2.4 MPa.

The compression set value for a specific pressure is determined by the difference between the thickness measured at this pressure during the first loading cycle and the thickness measured at this pressure during the third loading cycle.

Preferably, the GDL according to the present disclosure exhibits a compression set value at 6 bar (0.6 MPa), measured according to the method described above on an annular sample with an inner diameter of 45 mm and an outer diameter of 56 mm on a GDL with an area weight of 90 to 95 g/m² and an MPL loading of 15.0 to 22.0 g/m² of at most 6 μm.

The specifying of the thickness of the gas diffusion layer can be carried out in accordance with DIN 53855-1:1993-08 “Specifying the thickness of textile sheet-like structures”. The thickness can be specified at a specific compressive force (e.g. at 0.025 MPa or at 1.0 MPa) in a device for measuring the compression set, as described in detail above.

The specifying of the mass per unit area in g/m² can be carried out in accordance with ISO 9073-1 or EN 29073-1:1992.

### Fuel Cell

An aspect of the present disclosure include a fuel cell comprising at least one gas diffusion layer as described herein or obtainable by a process as described herein.

In principle, the gas diffusion layer according to the present disclosure is suitable for all conventional fuel cell types. Preferably, the fuel cell according to the present disclosure is a proton exchange membrane fuel cell (PEMFC). Proton exchange membrane fuel cells are also referred to as polymer electrolyte fuel cell (PEFC) or low temperature polymer electrolyte membrane fuel cell (LT-PEMFC). Embodiments of the present disclosure include water-oxygen fuel cells in the form of low-temperature proton exchange membrane fuel cells (PEMFC). Full reference is made to the previous embodiments on the structure of fuel cells.

The fuel cells according to the present disclosure preferably comprise a polymer electrolyte membrane onto which a catalyst layer is applied on the anode and cathode side, which forms the electrodes. Preferably, a gas diffusion layer (GDL) is in contact with the catalyst layer on the anode and/or cathode side. In particular, the fuel cells feature a polymer electrolyte membrane onto which a catalyst layer is applied, which is in contact with the surface of the microporous layer B) of a gas diffusion layer according to the present disclosure. In particular, the fuel cells feature a gas diffusion layer according to the present disclosure on the cathode side, wherein the catalyst layer is in contact with the surface of the microporous layer B) of the gas diffusion layer. More specifically, the fuel cells feature a gas diffusion layer according to the present disclosure on the cathode side and on the anode side, wherein both the cathode layer and the anode layer are each in contact with the surface of the microporous layer B) of a gas diffusion layer according to the present disclosure.

It is an advantage of the present disclosure that the transport processes through the gas diffusion layer can be specifically adapted to the gradients of the operating media flowing through the fuel cell and/or the operating parameters of the fuel cell. Correspondingly, at least one property gradient of the gas diffusion layer typically corresponds to at least one of the property gradients of the operating media flowing through the fuel cell and/or the operating parameters of the fuel cell.

An aspect of the present disclosure includes the use of a gas diffusion layer, as described herein, or obtainable by a process, as described herein, in a proton exchange membrane fuel cell.

The following examples serve to illustrate examples of the present disclosure without limiting it in any way.

### EXAMPLES

### I) Production of Gas Diffusion Layers

### Production Example 1

Production of a gas diffusion layer according to the present disclosure and a comparative diffusion layer with a property gradient in the x-direction.

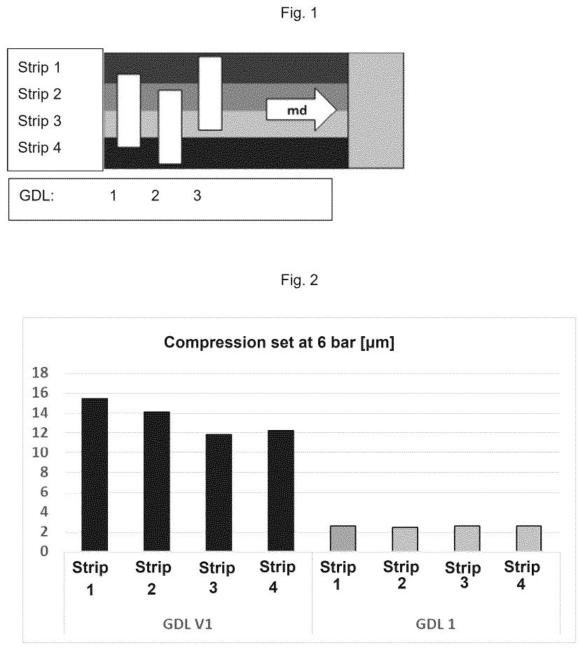

Sheets in DIN A3 format (29.7×42 cm) were punched out from the GDL roll in the longitudinal direction (machine direction, md) and individually coated from a commercially available electrically conductive fiber web with a thickness of 0.145 mm, an area weight of 60 g/m² and a through plane resistance (through plane) of 6.6 m² Ωcm² at 1 MPa compression. To produce a microporous layer with a property gradient, 4 laterally adjacent strips of MPL pastes, each 7 to 8 cm wide, were applied in the longitudinal direction of the fiber web (see FIG. 1). The pastes had a composition according to Table 1. For their production, PTFE, various carbons and plastic particles as pore-forming agents were dispersed in distilled water and applied to the fiber web by doctoring with a doctor blade gap of 240 μm. Subsequently the sheets were dried at 160 °C and sintered at 400 °C. The resulting MPL loadings ranged from 15 to 22 g/m², depending on the strip.

TABLE 1

| | PTFE | Carbon | Pore-forming | Solids |
|---|---|---|---|---|
| | [% by | [% by | agent [% by | content [% by |
| | weight]¹⁾ | weight]¹⁾ | weight]¹⁾ | weight]¹⁾ |
| Paste 1 | 2.3 | 9.3 | 0 | 11.6 |
| Paste 2 | 1.9 | 7.7 | 0.2 | 9.8 |
| Paste 3 | 2.1 | 8.3 | 0.4 | 10.8 |
| Paste 4 | 2.1 | 8.4 | 0.4 | 10.9 |

It should be noted that in Table 1 for the Solids content [% by weight], in each case it is based on the total weight of the sintered paste. Gas diffusion layers having the format of 274.8×96.5 mm were punched out from the obtained sheets with the long side perpendicular to the machine direction. FIG. 1 shows 3 alternative punching positions. The obtained GDLs have a property gradient in the direction of the x-axis, wherein GDL 1 has 4 strips each with different properties and GDL 2 and 3 each have 3 strips with different properties.

For the production of a fuel cell, for example, the GDL can be installed in such a way that the x-direction (long side) is in the direction of the direct connection between the supply and discharge of the operating materials to the flow distributor plate. In the case of a flow distributor plate with straight channels, the long side of the GDL is thus parallel to the gas channels. But even with a different flow field design, the installation can be carried out, for example, in such a way that the O₂-rich fuel supplied on the cathode side (air side) of the fuel cell first comes into contact with the microporous layer (MPL) (layer 1) formed by paste 1 and the O₂-poor fuel being discharged comes into contact with the microporous layer MPL (layer 4) formed by paste 4.

### II) Examples

The comparative GDL V1 and the GDL 1 according to the present disclosure, which each have 4 strips, were used for the measurements described below.

The determining of the compression set values was carried out according to the method described in detail above. This method was also used to specify the thickness, gas permeability, dry diffusion length and electrical resistance, in each case at a specific compressive force without prior force application/in the first loading process. The values are given in the Table 2 below.

The Gurley gas permeability was specified in each case perpendicular to the material plane using a Gurley densometer from the company Gurley Precision Instruments in accordance with ISO 5636-5. The results can also be seen in Table 2.

The dry diffusion length was specified using a stationary Wicke-Kallenbach cell. The results can also be found in Table 2.

The specifying of the (specific) electrical resistance through the plane (through plane, TP) was carried out by 4-point measurement.

The post-treatment of the gas diffusion layers according to the present disclosure at increased pressure and temperature leads to a significant reduction in the proportion of plastic deformation. FIG. 2 shows this using the compression set values at 6 bar. The deformation of the post-treated GDL is predominantly elastic. Furthermore, a clear homogenization of the setting behavior of the different strips is also evident. The variance of the setting behavior from strip to strip decreases significantly.

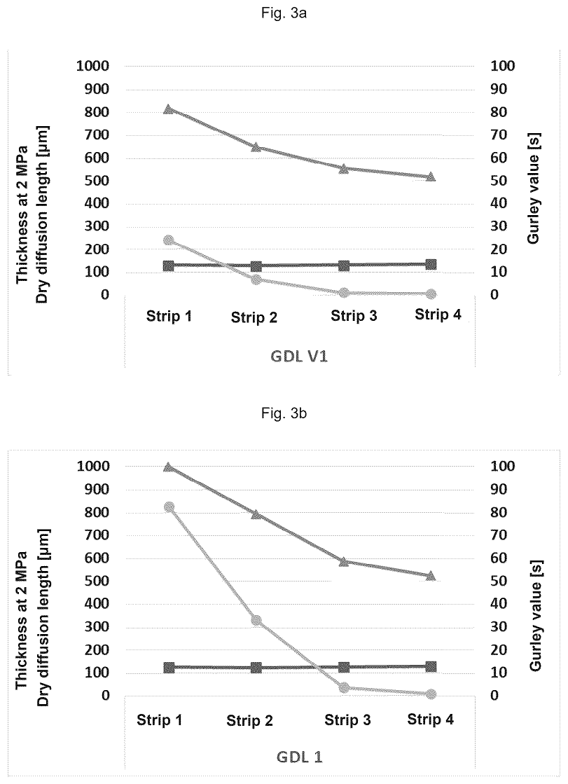

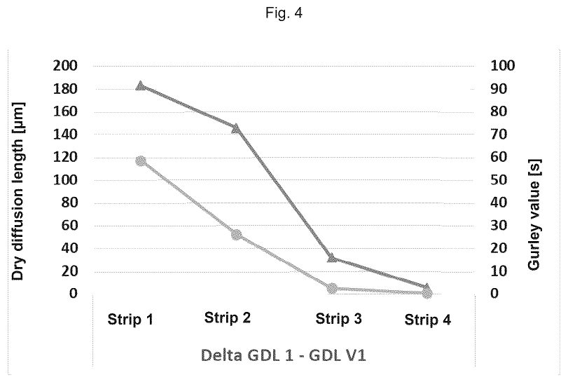

FIGS. 3a, 3b and 4 show the influence of the post-treatment according to the present disclosure on the transport properties of the GDL and their gradients based on the dry diffusion length and the Gurley values. Depending on the composition of the strips, the transport properties change significantly (strips 1 and 2) and/or only slightly (strips 3 and 4) as a result of the treatment at elevated pressure and elevated temperature. This can be used to control the characteristics of the gradients as required. In Table 2, below, TP=through plane.

TABLE 2

| | | GDL V1 | | | | GDL 1 | | | |
|---|---|---|---|---|---|---|---|---|---|
| | | Strip | Strip | Strip | Strip | Strip | Strip | Strip | Strip |
| Feature | Unit | 1 | 2 | 3 | 4 | 1 | 2 | 3 | 4 |
| MPL loading | g/m² | 21.1 | 15.5 | 15.2 | 15.8 | 21.3 | 15.9 | 14.6 | 15.9 |
| Solids content MPL | % | 11.50 | 9.64 | 10.02 | 11.09 | 11.50 | 9.64 | 10.02 | 11.09 |
| strips sintered | | | | | | | | | |
| Area weight GDL | g/m² | 95 | 92 | 91 | 94 | 94 | 91 | 93 | 94 |
| strips | | | | | | | | | |
| Thickness at 0.025 | μm | 177 | 181 | 182 | 186 | 154 | 151 | 154 | 159 |
| MPa | | | | | | | | | |
| Thickness at 0.6 | μm | 148 | 144 | 145 | 149 | 132 | 130 | 133 | 136 |
| MPa | | | | | | | | | |
| Thickness at 1.0 | μm | 141 | 136 | 139 | 142 | 128 | 127 | 130 | 133 |
| MPa | | | | | | | | | |
| Thickness at 2.0 | μm | 130 | 127 | 130 | 133 | 124 | 122 | 125 | 128 |
| MPa | | | | | | | | | |
| Compression set at | [μm] | 15.4 | 14.1 | 11.8 | 12.2 | 2.6 | 2.4 | 2.6 | 2.6 |
| 0.6 MPa | | | | | | | | | |
| (Difference 1st/3rd | | | | | | | | | |
| cycle) | | | | | | | | | |
| Compression set at | μm | 11.4 | 9.5 | 8.3 | 8.8 | 2.1 | 2.0 | 2.0 | 2.0 |
| 1.0 MPa | | | | | | | | | |
| (Difference 1st/3rd | | | | | | | | | |
| cycle) | | | | | | | | | |
| Compression set at | μm | 5.0 | 4.0 | 3.8 | 4.1 | 1.1 | 1.1 | 1.2 | 1.2 |
| 2.0 MPa | | | | | | | | | |
| (Difference 1st/3rd | | | | | | | | | |
| cycle) | | | | | | | | | |
| Resistance TP at 0.6 | mΩcm² | 2.0 | 1.8 | 1.5 | 1.4 | 2.5 | 2.4 | 2.0 | 2.0 |
| MPa | | | | | | | | | |
| 4-point, 1st cycle | | | | | | | | | |
| Resistance TP at 1.0 | mΩcm² | 1.7 | 1.5 | 1.3 | 1.2 | 2.0 | 2.0 | 1.6 | 1.6 |
| MPa | | | | | | | | | |
| 4-point, 1st cycle | | | | | | | | | |
| Resistance TP at 2.0 | mΩcm² | 1.3 | 1.2 | 1.0 | 0.9 | 1.6 | 1.6 | 1.4 | 1.3 |
| MPa | | | | | | | | | |
| 4-point, 1st cycle | | | | | | | | | |
| Gurley gas | s | 24.1 | 6.8 | 1.0 | 0.6 | 82.8 | 33.0 | 3.6 | 0.9 |
| permeability | | | | | | | | | |
| Dry diffusion length | μm | 817 | 648 | 553 | 518 | 1.000 | 793 | 585 | 523 |

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for producing a gas diffusion layer for a fuel cell, comprising:
A) a flat electrically conductive fiber material; and
B) a microporous layer on at least one of the surfaces of the fiber material,
wherein the microporous layer relative to a base surface of the gas diffusion layer, in an x, y plane, has at least one property gradient with respect to at least one chemical and/or physical property,
wherein:
i) the flat electrically conductive fiber material A) is provided,
ii) the fiber material provided in step i) is coated with a precursor to form the microporous layer, wherein a composition of the precursor is varied to produce a gradient,
iii) the coated fiber material obtained in step ii) is subjected to a post-treatment at elevated pressure and/or elevated temperature.

2. The method according to claim 1, wherein the treatment in step iii) is carried out at a pressure in a range from 0.5 to 10.0 MPa.

3. The method according to claim 1, wherein the treatment in step iii) is carried out at a temperature in a range from 100 to 350 °C.

4. The method according to claim 1, wherein for the treatment in step iii) a device is used, wherein the device includes at least one of: single-deck presses, multi-deck presses, endless belt presses, calenders, or double belt presses.

5. The method according to claim 1, wherein the treatment in step iii) is carried out in a press over a period of time of from 5 seconds to 5 minutes.

6. The method according to claim 1, wherein the treatment in step iii) is carried out in a calender over a period of time of greater than 0 seconds to 10 seconds.

7. The method according to claim 1, wherein the treatment in step iii) is carried out in a calender at a line pressure in a range from 5 to 500 N/mm, preferably 10 to 100 N/mm.

8. The method according to claim 1, wherein the composition of the precursor is varied during coating such that the microporous layer has at least a monotonic property gradient with respect to a base area of the gas diffusion layer in the x, y plane.

9. A gas diffusion layer obtainable by the method as defined in claim 1.

10. A gas diffusion layer for a fuel cell, comprising:
A) a flat electrically conductive fiber material; and
B) a microporous layer on at least one of the surfaces of the fiber material,
wherein the gas diffusion layer has, in relation to its base area, in an x, y plane, at least one property gradient with respect to at least one chemical and/or physical property, and wherein the gas diffusion layer has been subjected to a post-treatment at elevated pressure and/or elevated temperature, so that the gas diffusion layer has a reduced plastic deformability compared to a non-post-treated gas diffusion layer.

11. The gas diffusion layer according to claim 10, which has a reduced compression set value compared to the non-post-treated gas diffusion layer.

12. The gas diffusion layer according to claim 10, wherein the at least one property gradient is a continuous or erratic property gradient, which varies monotonically as a function of location.

13. The gas diffusion layer according to claim 10, wherein the microporous layer has at least 2, preferably at least 3, in particular at least 4 areas which differ in at least one property.

14. The gas diffusion layer according to claim 10, wherein the property comprising a gradient is selected from
a chemical composition of the flat fiber material A) and/or the microporous layer B),
mechanical properties of the flat fiber material A) and/or the microporous layer B),
transport properties of the flat fiber material A) and/or the microporous layer B),
or combinations thereof.

15. The gas diffusion layer according to claim 10, comprising a gradient of dry diffusion length and/or Gurley gas permeability.

16. A fuel cell comprising at least one gas diffusion layer as defined in claim 10.

17. The fuel cell according to claim 16, comprising a polymer electrolyte membrane onto which a catalyst layer is applied, wherein the catalyst layer is in contact with the surface of the microporous layer B) of the gas diffusion layer.

18. A proton exchange membrane fuel cell comprising a gas diffusion layer obtainable by a method as defined in claim 1.
